(19) United States
(12) Patent Application Publication
(10) Pub. No.: US 2025/0314582 A1
(43) Pub. Date: Oct. 9, 2025

(54) OPEN-PATH OPTICAL SENSORS FOR ANALYTE MEASUREMENTS

(71) Applicant: The Trustees of Princeton University, Princeton, NJ (US)

(72) Inventors: Mark Zondlo, Princeton, NJ (US); Vladislav Sevostianov, Princeton, NJ (US); Paul Guiguizian, Princeton, NJ (US); Josh Collins, Princeton, NJ (US); Hongming Yi, Princeton, NJ (US); Lei Tao, Princeton, NJ (US); Da Pan, Fort Collins, CO (US); Dan Moore, Princeton, NJ (US); James McSpiritt, Princeton, NJ (US); Nathan Li, Princeton, NJ (US)

(21) Appl. No.: 19/174,712

(22) Filed: Apr. 9, 2025

Related U.S. Application Data
(60) Provisional application No. 63/631,902, filed on Apr. 9, 2024.

(51) Int. Cl. G01N 21/3504; B64U 10/13; B64U 101/35

(52) U.S. Cl. CPC G01N 21/3504; B64U 10/13; B64U 2101/35; G01N 2021/3513; G01N 2201/0216; G01N 2201/0636

(57) ABSTRACT

Systems and methods are provided for measuring analytes in the air over an area. Open-path sensing equipment can be used to measure the concentration of one or more analytes over the area. The open-path sensing equipment can include at least one light source configured to provide light at a respective predetermined wavelength, a detector, and a plurality of mirrors. The open-path sensing equipment can further include and/or be operated with electronics, such as field programmable gate array (FPGA) electronics.

### CROSS-REFERENCE TO RELATED APPLICATION

This application claims the benefit of U.S. Provisional Application Ser. No. 63/631,902, filed Apr. 9, 2024, the disclosure of which is hereby incorporated by reference in its entirety, including all figures, tables, and drawings.

### GOVERNMENT SUPPORT

This invention was made with government support under Grant No. DE-AR0001385 awarded by the Department of Energy and under Grant No. 68HERH21D0006 awarded by the Environmental Protection Agency. The government has certain rights in the invention.

### BACKGROUND

In agriculture, many greenhouse gases and air pollutants are generated and degrade environment. Thus, limits may be placed by government on the amount of emissions that a particular farm or field may produce before fines, mitigation efforts, or specific reporting requirements can be implemented. If the actual generation of a particular gas is below the limit, the difference can be sold in a carbon credit market, touted as a sustainability metric, or marketed as a form of environmental stewardship, all of which may generate income for the owner of the farm or field. In addition, scientific researchers also want to quantify emissions of these gases to help understand how operator practices, meteorological conditions, and other interventions may increase or decrease such emissions. It is therefore important to accurately measure greenhouse gas and air pollutant emissions from agricultural activities.

### BRIEF SUMMARY

Embodiments of the subject invention provide novel and advantageous systems and methods for measuring analytes (e.g., greenhouse gases, such as nitrous oxide (N₂O) and air pollutants such as ammonia (NH₃)) in the air over a field or other area (e.g., a field in an agricultural setting; a grassland, above a water body surface such as a lake, river, or ocean; above a forest canopy; over an industrial facility). The system can include sensing equipment with an open-path configuration using at least one light source configured to provide light at a respective predetermined wavelength (e.g., a mid-infrared (mid-IR) wavelength). Open-path sensing equipment or sensor means that air is passively brought through the sample volume either through wind or the motion of the sensing equipment or sensor (e.g., via a moving vehicle or object), and the sampling volume is exposed directly to the environmental conditions. The sensing equipment can also include other optical components, such as one or more steering mirrors, one or more focusing mirrors, and/or a detector. The system can have fast response (e.g., in a range of from 1 Hertz (Hz) to 1000 Hz, such as 10 Hz) and low power consumption. In one configuration, the sensing equipment for measuring the concentration of one or more analytes over the field (or other area) can be attached to or mounted on an unmanned aerial vehicle (UAV) . . . . In another configuration, the sensing equipment can be mounted to or attached to a tower or a moving ground vehicle or ground object (e.g., a moving platform).

In an embodiment, a system for measuring at least one analyte in air over an area (such as over a field (e.g., an agricultural field) or other areal surface) can comprise: an airborne vehicle; open-path sensing equipment mounted on the open-path airborne vehicle; and an analyzer unit in operable communication with the open-path sensing equipment. Open-path sensing equipment or sensor means that air is passively brought through the sample volume either through wind or the motion of the sensing equipment or sensor (e.g., via an airborne vehicle), and the sampling volume is exposed directly to the environmental conditions. The open-path sensing equipment can comprise: at least one mid-infrared (mid-IR) laser disposed thereon and configured to provide light at a predetermined wavelength for a particular analyte, wherein the predetermined wavelength is in a range of from 2 micrometers (μm) to 30 μm; a plurality of reflection (or focusing) mirrors configured to reflect light from each mid-IR laser; and a detector configured to receive signals of light reflected from the plurality of reflection mirrors. The system can further comprise a meteorology station in operable communication with the analyzer unit, and the meteorological station can be configured to obtain meteorological data of the air being sampled by the system. The meteorological data can comprise wind speed, wind direction, air pressure, air temperature, humidity, or a combination thereof. The meteorology station can be disposed within or adjacent to the field, if the air being sampled is air over a field. Each analyte of the at least one analyte can be a greenhouse gas or air pollutant (e.g., N₂O, NH₃, methane (CH₄), carbon dioxide (CO₂), ozone (O₃) or a combination thereof). The system can be configured to measure the at least one analyte with a precision resolving about 1 part in 1000 of the ambient level of each respective gas in the atmosphere away from nearby sources (i.e., background levels). This is on the order of 10 parts per billion (ppb) or less (such as, for example 100 ppb for CO₂, 0.1 ppb for N₂O, 0.1 ppb for NH₃, and 0.1 ppb for O₃). The system can be configured to measure the at least one analyte with a sensitivity/precision of 100 ppb or less, 10 ppb or less, 1 ppb or less, 0.1 ppb or less, 0.1 ppb, or about 0.1 ppb. Each reflection mirror of the plurality of reflection mirrors can be a spherical mirror and/or can be gold-coated. The open-path sensing equipment can further comprise a pair of alignment mirrors. Each alignment mirror of the pair of alignment mirrors can be flat and/or can be gold-coated. The open-path sensing equipment can further comprise a first rigid box in which the at least one mid-IR laser, the plurality of reflection mirrors, and the detector are disposed. The first rigid box can comprise a metal (e.g., aluminum, such as anodized aluminum). The open-path sensing equipment can further comprise rods (which may be adjustable rods) between reflection mirrors of the plurality of reflection mirrors. The rods can be, for example, carbon fiber rods. The open-path sensing equipment can further comprise an off-axis parabolic mirror configured to focus the light reflected from the plurality of reflection mirrors onto the detector. The system can further comprise a second rigid box (which can be referred to herein as an electronics box) mounted on the open-path airborne vehicle and containing the analyzer unit. The first rigid box can comprise a metal (e.g., aluminum, such as anodized aluminum). The open-path sensing equipment can be configured such that the light has a plurality of passes (e.g., in a range of from 2 passes to 200 passes, such as from 10 passes to 100 passes). The analyzer unit can comprise software stored thereon that is configured to receive the signals of light reflected from the plurality of reflectors and convert them to data indicative of a concentration of the at least one analyte in the air. The analyzer unit can convert the signals via wavelength modulation spectroscopy, direct absorption spectroscopy, or both. The data indicative of the concentration of the at least one analyte in the air can comprise spatial information of the concentration of the at least one analyte in the air. The system can further comprise a display in operable communication with the analyzer unit, and the analyzer unit can be configured to display the data indicative of the concentration of the at least one analyte in the air on the display. The analyzer unit can comprise an FPGA. The at least one mid-IR laser can comprise a quantum cascade laser (QCL), an interband cascade laser (ICL), an antimonide laser, a lead-salt laser, and/or a laser beam coming from a combination of lasers such as ones from frequency combs or difference frequency generation. The open-path sensing equipment can be configured to operate (i.e., measure concentrations) at a frequency in a range of from 1 Hertz (Hz) to 1000 Hz (e.g., 10 Hz). The system can further comprise a global positioning satellite (GPS) receiver disposed on the airborne vehicle and in operable communication with the open-path sensing equipment. The system can further comprise an external battery disposed on the airborne vehicle and configured to provide power to the open-path sensing equipment. The system can be configured such that during operation the system uses a power of 10 watts (W) or less (e.g., 6 W or less, 6 W, or about 6 W). The system excluding the airborne vehicle can have a total weight of about 3 kilograms (kg) or less (e.g., in a range of from 0.5 kg to about 3 kg or from about 2 kg to about 3 kg). The airborne vehicle can be a UAV, such as a fixed-wing plane or a multi-rotor helicopter.

In another embodiment, a method for measuring at least one analyte in air over an area (such as over a field (e.g., an agricultural field) or other areal surface) can comprise: i) providing a system as disclosed herein (such as one having any combination of features from the previous paragraph); ii) operating the open-path sensing equipment; iii) operating the airborne vehicle such that it moves over at least a majority of the area while the open-path sensing equipment is being operated; and iv) using the analyzer unit to convert signals of reflected light in the open-path sensing equipment to data indicative of a concentration of the at least one analyte in the air. The method can further comprise displaying, on a display in operable communication with the analyzer unit, the data indicative of a concentration of the at least one analyte in the air.

In an embodiment, a system for measuring at least one analyte in air over and/or adjacent to an area (such as over a field (e.g., an agricultural field) or other areal surface) can comprise: open-path sensing equipment; and an analyzer unit in operable communication with the open-path sensing equipment. The open-path sensing equipment can comprise: at least one mid-infrared (mid-IR) light source disposed thereon and configured to provide light at a predetermined wavelength for a particular analyte, wherein the predetermined wavelength is in a range of from 2 micrometers (μm) to 30 μm; a plurality of reflection (or focusing) mirrors configured to reflect light from each mid-IR light source (such as a multiple-pass, Herriott cell); and a detector configured to receive signals of light reflected from the plurality of focusing mirrors. The system can further comprise a plurality of focusing lenses and a plurality of focusing windows, and the detector can be configured to receive the signals of light reflected from the plurality of focusing mirrors, the plurality of focusing lenses, and the plurality of focusing windows. The system can further comprise a meteorology station in operable communication with the analyzer unit, wherein the meteorological station is configured to obtain meteorological data of the air over the field, air adjacent to the field, or both. The meteorological data can comprise wind speed, wind direction, air pressure, air temperature, or a combination thereof. The meteorology station can be disposed within or adjacent to the field. Each analyte of the at least one analyte can be a greenhouse gas or air pollutant (e.g., N₂O, NH₃, CH₄, CO₂, O₃, or a combination thereof). The system can be configured to measure the at least one analyte with a precision resolving about 1 part in 1000 of the ambient level of each respective gas in the atmosphere away from nearby sources (i.e., background levels). This is on the order of ppb or less (such as, for example, 100 ppb for CO₂, 0.1 ppb for N₂O, 0.1 ppb for NH₃, and 0.1 ppb for O₃). The system can be configured to measure the at least one analyte with a sensitivity/precision of 100 ppb or less, 10 ppb or less, 1 ppb or less, 0.1 ppb or less, 0.1 ppb, or about 0.1 ppb. Each focusing mirror of the plurality of focusing mirrors can be attached to a three-axis mirror mount (which can be attached to a plate in a chamber of the open-path sensing equipment). Each focusing mirror of the plurality of focusing mirrors can be, for example, a molybdenum mirror. Each focusing mirror can be spherical, cylindrical, or astigmatic in shape and used to reflect the laser light many times within the unenclosed space between the focusing mirrors. The open-path sensing equipment can further comprise at least one alignment mirror. Each alignment mirror of the at least one alignment mirror can be, for example, a molybdenum mirror. The open-path sensing equipment can further comprise two chambers attached to each other by a plurality of rods. Each chamber of the two chambers can comprise a plurality of plates each covered with a cylindrical cowling. Each rod of the plurality of rods can be adjustable, can be hollow, and/or can be a carbon fiber rod. Each focusing mirror of the plurality of focusing mirrors can comprise a transparent coating window. The transparent coating window can be flat or wedged, or recessed within the respective focusing mirror. Each focusing mirror of the plurality of focusing mirrors can comprise a central hole configured to mount a self-cleaning mechanism. The open-path sensing equipment can further comprise a heat pipe attached to the at least one light source, and the heat pipe can comprise a conductive material (e.g., copper). The system can further comprise a rigid box containing the analyzer unit. The analyzer unit can comprise software stored thereon that is configured to receive the signals of light reflected from the plurality of reflectors and convert them to data indicative of a concentration of the at least one analyte in the air. The analyzer unit can converts the signals via wavelength modulation spectroscopy, direct absorption spectroscopy, or both. The data indicative of the concentration of the at least one analyte in the air can comprise spatial information of the concentration of the at least one analyte in the air. The system can further comprise a display in operable communication with the analyzer unit, and the analyzer unit can be configured to display the data indicative of the concentration of the at least one analyte in the air on the display. The analyzer unit can comprise a field programmable gate array (FPGA). The at least one mid-IR light source can comprise at least one laser (e.g., a QCL, an ICL, an antimonide laser, a lead-salt laser, a difference frequency generated light at this wavelength, or light from a frequency comb). The open-path sensing equipment can be configured to operate (i.e., measure concentrations) at a frequency in a range of from 1 Hertz (Hz) to 1000 Hz (e.g., 10 Hz). The system can further comprise at least one power source configured to provide power to the open-path sensing equipment. The system can be configured such that during operation the system uses a power of 60 watts (W) or less (e.g., 50 W or less, 50 W, or about 50 W). The open-path sensing equipment can be mounted on a tower disposed in or adjacent to the field. Alternatively, the open-path sensing equipment can be mounted on a moving object. The system can be configured to operate without failure at all temperatures in a range of from −40° C. to 60° C. The open-path sensing equipment can have a circular and/or cylindrical shape. The open-path sensing equipment can be deployed with a fast measurement of three-dimensional wind velocity nearby the sensing equipment to deduce flux concentrations by linking the vertical components of the wind velocity to changes in the concentrations at similar frequencies.

In another embodiment, a method for measuring at least one analyte in air over and/or adjacent to an area (such as over a field (e.g., an agricultural field) or other areal surface) can comprise: i) providing a system as disclosed herein (such as one having any combination of features from the previous paragraph); ii) operating the open-path sensing equipment; and iii) using the analyzer unit to convert signals of reflected light in the open-path sensing equipment to data indicative of a concentration of the at least one analyte in the air. The method can further comprise displaying, on a display in operable communication with the analyzer unit, the data indicative of a concentration of the at least one analyte in the air.

### BRIEF DESCRIPTION OF THE DRAWINGS

FIG. 1 shows an image of an unmanned aerial vehicle (UAV) having open-path sensing equipment attached thereto, according to an embodiment of the subject invention. The UAV is hovering above a field.

FIG. 2 shows a schematic view of a portion of open-path sensing equipment, according to an embodiment of the subject invention. Though FIG. 2 lists certain dimensions, materials, and component types, these are for exemplary purposes only and should not be construed as limiting.

FIG. 3 shows a schematic view of a portion of open-path sensing equipment, according to an embodiment of the subject invention. Though FIG. 3 lists certain dimensions, materials, and component types, these are for exemplary purposes only and should not be construed as limiting.

FIG. 4 shows a schematic view of a portion of open-path sensing equipment, according to an embodiment of the subject invention. Though FIG. 4 lists certain dimensions, materials, and component types, these are for exemplary purposes only and should not be construed as limiting.

FIG. 5 shows a schematic view of a portion of open-path sensing equipment, according to an embodiment of the subject invention. Though FIG. 5 lists certain dimensions, materials, and component types, these are for exemplary purposes only and should not be construed as limiting.

FIG. 6 shows a schematic view of a portion of open-path sensing equipment, according to an embodiment of the subject invention. Though FIG. 6 lists certain dimensions, materials, and component types, these are for exemplary purposes only and should not be construed as limiting.

### DETAILED DESCRIPTION

Embodiments of the subject invention provide novel and advantageous systems and methods for measuring analytes (e.g., greenhouse gases, such as nitrous oxide (N₂O) and air pollutants such as ammonia (NH₃)) in the air over a field or other area (e.g., a field in an agricultural setting; a grassland, above a water body surface such as a lake, river, or ocean; above a forest canopy; over an industrial facility). The system can include sensing equipment with an open-path configuration using at least one light source configured to provide light at a respective predetermined wavelength (e.g., a mid-infrared (mid-IR) wavelength). Open-path sensing equipment or sensor means that air is passively brought through the sample volume either through wind or the motion of the sensing equipment or sensor (e.g., via a moving vehicle or object), and the sampling volume is exposed directly to the environmental conditions. The sensing equipment can also include other optical components, such as one or more steering mirrors, one or more focusing mirrors, and/or a detector. The system can have fast response (e.g., in a range of from 1 Hertz (Hz) to 1000 Hz, such as 10 Hz) and low power consumption. In one configuration, the sensing equipment for measuring the concentration of one or more analytes over the field (or other area) can be attached to or mounted on an unmanned aerial vehicle (UAV). In another configuration, the sensing equipment can be mounted to or attached to a tower or a moving ground vehicle or ground object (e.g., a moving platform).

In some embodiments, a UAV can have open-path sensing equipment attached thereto (or mounted thereon) for measuring the concentration of one or more analytes over the field (or other area). The sensing equipment can include at least one light source (e.g., laser or light-emitting diode (LED)) configured to provide light at a respective predetermined wavelength (e.g., a mid-infrared (mid-IR) wavelength), a detector configured to measure mid-IR light (e.g., a mercury cadmium telluride (MCT) detector, an InGaAs-based detector, or a Sb-based detector), and a plurality of mirrors (e.g., metal-coated mirrors, such as gold-coated mirrors). The sensing equipment can further include and/or be operated with electronics, such as field programmable gate array (FPGA) (e.g., custom FPGA) electronics. The sensing equipment, optionally including the electronics (e.g., in an electronics box), can be mounted on the UAV to produce spatial maps of concentrations and/or emissions or one or more target analytes and can be applied (e.g., together with other sensors and/or measurements) to understand concentrations, emissions, deposition rates, and/or fluxes of analytes.

Related art sensing technology is not capable of measuring greenhouse gases and air pollutants (e.g., N₂O and NH₃) in an open-path configuration with a multi-pass cell, mid-IR coherent light source, and laser absorption spectroscopy. Embodiments of the subject invention are capable of doing so using compact, lightweight, and low power sensing equipment that can include at least one mid-IR laser, a detector, and a plurality of mirrors. The sensing equipment can be mounted on a UAV (or other mobile platforms such as small aircraft, vehicles, etc.) and used for spatial mapping of concentrations, emissions, and/or identification of sources for a target analyte (or target analytes). Because of the frequency range in which the sensing equipment operates, it can also be used in eddy covariance measurement applications, and because of the high sensitivity/precision of the sensing equipment, it can also be used for eddy covariance flux measurements.

The UAV-based systems of embodiments of the subject invention can map out concentrations across any environment in which they fly, whether a cropland, grassland, forest, industrial facility, or water body such as a lake, ocean, or river. The UAV-based systems also have the advantage of being able (and/or configured) to capture vertical profiles of trace gases in the atmosphere, such as greenhouse gases and air pollutants, along with naturally-occurring emissions of such gases. The UAV-based systems can also map and localize emission sources across a domain.

The sensing equipment can operate at a frequency in a range of, for example, from 1 Hertz (Hz) to 1000 Hz (or any subrange contained therein, such as from 1 Hz to 100 Hz or from 1 Hz to 10 Hz). In many embodiments, the sensing equipment operates at a frequency of 10 Hz.

The sensing equipment can use rods, such as carbon fiber rods, between the mirrors to minimize temperature sensitivity and mass. An insulating material, such as anodized aluminum, can be used to make the sensing equipment electrically-insulating. The sensing equipment can be attached to a UAV using, for example, spring mounts to minimize vibrations.

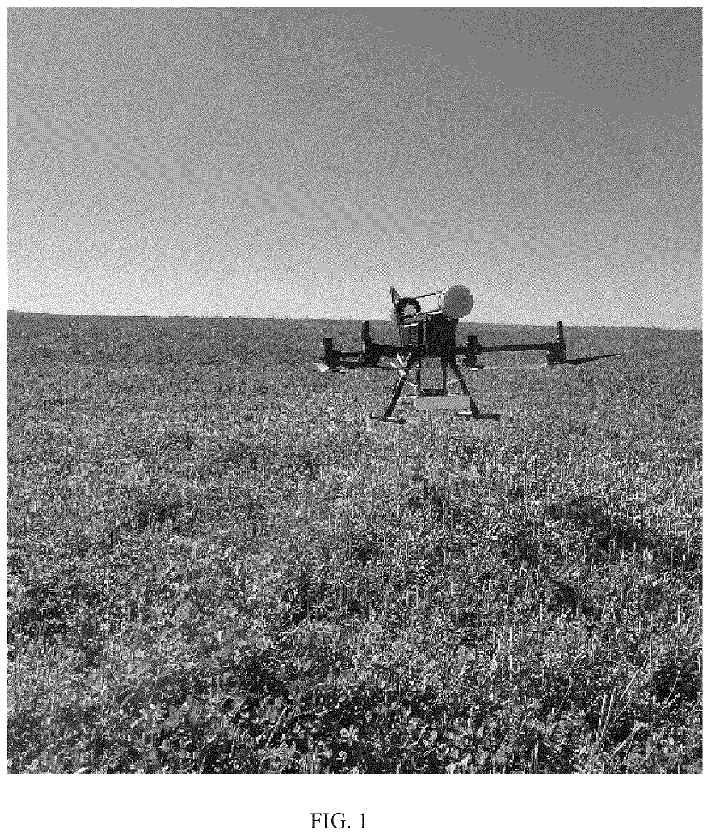

FIG. 1 shows an image of a UAV having sensing equipment attached thereto, according to an embodiment of the subject invention. Referring to FIG. 1, the sensing equipment can have a rigid body, for example made of metal (e.g., aluminum). In an embodiment, the rigid body can be machined from aluminum and then anodized. Adjustable rods (e.g., carbon fiber rods) can be used to hold the cell (with the laser, detector, and mirrors) together and minimize thermal expansion. Optical mounts (e.g., aluminum optical mounts) can be used to hold two alignment mirrors and the laser. The mirrors can include alignment mirrors, which can be, for example, flat alignment mirrors and can be coated, for example with a metal (e.g., gold, silver, or aluminum). The mirrors can be, for example, ½-inch flat alignment mirrors. The (or each) laser can be, for example, an interband cascade laser (ICL) or a quantum cascade laser (QCL). The mirrors can include reflection (or focusing) mirrors, which can be, for example, spherical reflection mirrors and can be coated, for example with a metal (e.g., gold). The reflection mirrors can be, for example, 2-inch spherical mirrors. The reflection mirrors can be window-free or can alternatively include a transmissive window for the wavelength of the laser light that is wedged or anti-reflectivity coated to minimize back reflections into the optical path. The reflection mirrors can have a slot (e.g., a water-jet cut slot) through which light can enter and leave the cell, either with or without a window. An off-axis parabolic mirror can be included to focus the light that exits the multi-pass cell onto a detector (e.g., a MCT detector and/or an image sensor) after a predetermined number of passes. The predetermined number of passes can depend upon the sensitivity desired and can be in a range of, for example, 2 to 200 passes (or any subrange contained therein, such as from 10 to 100 passes). Wiring for the detector can go through a shielded cable through the hollow rods (e.g., carbon fiber rods) between the mirrors. The sensing equipment can include one or more optical housings surrounding the back side of some or each of the mirrors, and any such optical housing can be, for example, three-dimensional (3D) printed (e.g., with 3D-printing materials, such as acrylonitrile butadiene styrene (ABS). All the electrical components and wires in the optical cell can be ultimately joined into a single shielded cable that can be in operable communication with an electronics box. For example, the electrical components and wires can be connected wirelessly or directly to an electronics box (e.g., an aluminum electronics box) that can house FPGA electronics (e.g., custom FPGA electronics). A global positioning satellite (GPS) receiver and/or an external battery can be included with the sensing equipment and/or the electronics box. The multi-pass cell can be disposed on, for example, an upper portion or top of the UAV to minimize impact on landing functionality of the UAV. The electronics box (if present) and/or battery (if present) can be disposed on, for example, a lower portion or bottom of the UAV to minimize impact on landing functionality of the UAV.

While all of the mirrors present (e.g., the alignment mirrors, the reflection mirrors, and the parabolic mirror) can be capable of reflecting light, the reflection mirrors are referred to herein as “reflection mirrors” because they are involved in the reflecting of the light between when it exits the laser and when it is detected by the detector.

Each laser can be configured to provide light at a wavelength in the mid IR range (i.e., 2 micrometers (μm) to 30 μm), and at a specific wavelength for a particular analyte. That is, the sensing equipment can include at least one laser, which can include a first laser configured to provide light at a first mid-IR wavelength targeted to obtain the concentration of a first analyte, a second laser configured to provide light at a second mid-IR wavelength targeted to obtain the concentration of a second analyte, a third laser configured to provide light at a third mid-IR wavelength targeted to obtain the concentration of a third analyte, and/or a fourth laser configured to provide light at a fourth mid-IR wavelength targeted to obtain the concentration of a fourth analyte, etc. In the case where more than one laser is present, only one laser is operated at a time to obtain the concentration of a single analyte at a time.

The portion of the sensing equipment including the (or each) laser, the detector, and the mirrors can be referred to herein as the sensor, the cell, or the multi-pass cell. The sensor can be operated with custom made FPGA electronics with an operating system (e.g., a Linux-based operating system) and a modbus interface. The sensor and the electronics box can be mounted on a UAV to produce spatial maps of concentrations and/or emissions, and can be applied (e.g., together with other sensors and/or measurements) to understand concentrations, emissions, and/or fluxes of greenhouse gases and/or air pollutants (e.g., N₂O, NH₃). The system can use wavelength modulation spectroscopy, direct absorption spectroscopy, or a combination thereof for obtaining concentrations. Systems and methods of embodiments of the subject invention allow for fast response with no sampling hysteresis, low power operation with FPGA-based electronics, and sufficiently light (e.g., less than 3.5 kilograms (kg), such as in a range of from 0.5 kg to 3 kg, from 2 kg to 3 kg, or from about 2 kg to about 3 kg) package for use on UAVs.

In some embodiments, the system can include an analyzer unit in operable communication with the sensor. The analyzer unit can be, for example, a computer with software stored thereon that is configured to receive the signals (or reflected light from the reflectors) and convert them to data indicative of the analyte concentration in the air. The optically absorbed signals can be converted via, for example, wavelength modulation spectroscopy or direct absorption spectroscopy, though embodiments are not limited thereto. The data indicative of the analyte concentration in the air can include spatial information (e.g., the concentration in space within the field). The data indicative of the analyte concentration can also include a flux of the analyte concentration. The analyzer unit can include custom FPGA electronics. The analyzer unit can be in the electronics box or can be remote (e.g., wirelessly connected to the sensor and/or the electronics box). The analyzer unit can be in operable communication with a display on which the data indicative of the analyte concentration in the air can be displayed. The display can be located on the electronics box or can be remote therefrom, in which case the data can be transmitted to the display wirelessly or via a wire (e.g., a buried wire). As the sensor moves around the field, a full picture of analyte concentration in the entire field can be obtained.

The systems and methods of embodiments of the subject invention can detect analyte concentration in the air with a sensitivity/precision of 500 parts per billion (ppb) or less, such as 100 ppb or less, 50 ppb or less, 10 ppb or less, 1 ppb or less, about 0.1 ppb, or 0.1 ppb. These sensitivities can be obtained in the operating frequency range of the sensor (e.g., 1 Hz to 1000 Hz, or at 10 Hz). Higher precision is possible with longer pathlengths in a linear relationship.

In some embodiments, due to the weight of the sensing equipment (including the electronics box) being in a range of from about 2 kg to about 3 kg, the UAV on which it is mounted must be sufficiently large (for example, the DJI Matric 350, the Tarot T-8, etc.). Further weight reductions can be done by using lighter materials than aluminum, but they must still be strong enough to ensure no distortion of the optical cell while providing electrical shielding for the sensor.

The sensing equipment can further include and/or be operated with electronics, such as field programmable gate array (FPGA) (e.g., custom FPGA) electronics. The sensing equipment, optionally including the electronics (e.g., in an electronics box) can be mounted on the UAV to produce spatial maps of concentrations and/or emissions or one or more target analytes and can be applied (e.g., together with other sensors and/or measurements) to understand concentrations, emissions, and/or fluxes of analytes.

The sensing equipment can be low power, using an amount of power during operation that is, for example, 20 watts (W) or less (e.g., 10 W or less, 6 W or less, in a range of from 1 W to 10 W, 6 W, or about 6 W).

The analyte can be a gas, such as N₂O, NH₃, methane (CH₄), carbon dioxide (CO₂), nitric oxide (NO), ozone (O₃), or carbon monoxide (CO). In some embodiments, the concentration in the air of more than one analyte can be detected, and each analyte may be a gas (such as those listed in the previous sentence).

In many embodiments, a meteorology station (e.g., a sonic anemometer or similar meteorological sensor) can be mounted on the UAV to record wind and/or other meteorological parameters. The sensing equipment and/or the analyzer unit can be in operable communication with the meteorology station. By combining the wind measurements with the concentration maps through inverse dispersion methods, an emission map can be created as a function of space and time.

In an embodiment, a method of fabricating a sensor as disclosed herein can comprise preparing and protecting the reflection mirrors by heating the reflection mirrors and coating the mirrors with a protective layer (e.g., a wax, such as paraffin wax). This heating and protective layer prepares and protects the reflection mirrors for a water jetting process. The reflection mirrors can then be cut using the water jetting process, then heated again, and the protective layer can be removed. Next, the reflection mirrors can be adhered (e.g., using epoxy) to a rigid plate (e.g., a metal plate, such as an aluminum plate) that is attached (e.g., with screws) to the rest of the rigid body (e.g., metal body, such as aluminum body) of the sensor.

In many embodiments, sensing equipment (which can also be referred to herein as a sensor or sensors) for measuring the concentration of one or more analytes over and/or adjacent to the field (or other area) can include at least one light source (e.g., a laser) configured to provide light at a respective predetermined wavelength (e.g., a mid-infrared (mid-IR) wavelength), a detector configured to measure mid-IR light (e.g., a MCT detector, an InGaAs-based detector, or a Sb-based detector), and a plurality of mirrors (e.g., metal-coated mirrors, such as with a molybdenum, gold, silver, or aluminum coating). The sensing equipment can further include and/or be operated with electronics, such as field programmable gate array (FPGA) (e.g., custom FPGA) electronics. The sensing equipment, optionally including the electronics (e.g., in an electronics box), can be mounted on a tower within or adjacent to the field to provide a measurement of the concentration of the one or more analytes. In some embodiments, the sensing equipment can be attached to or mounted on a moving vehicle or other moving object (e.g., a moving platform) to produce spatial maps of concentrations and/or emissions of one or more target analytes and can be applied (e.g., together with other sensors and/or measurements) to understand concentrations, emissions, depositions, and/or fluxes of analytes.

Many embodiments of the subject invention utilize a combination of newly developed features and components integrated together in a unique way to improve an existing flux measurement approach (eddy-covariance) and instrumentation. Eddy covariance is a micrometeorological flux measurement approach that is a very direct way to measure fluxes, but depends on specific meteorological conditions and assumptions, the full limitations of which are an active area of research worldwide. The sensors of embodiments of the subject invention are targeted for use in eddy covariance and are thus subject to the operating restrictions of the measurement technique. The sensors have particular environmental conditions in which they can operate well, such as when it is not raining or snowing, no colder than −40° C., and no warmer than 60° C. The temperature range can be expanded with the use of different electrical components and more active temperature control. The poor functioning in the rain is an inherent limitation of open-path sensors. Hydrophobic coatings on the mirrors and exposed optics can be used to improve performance in precipitation and under dew and frost conditions.

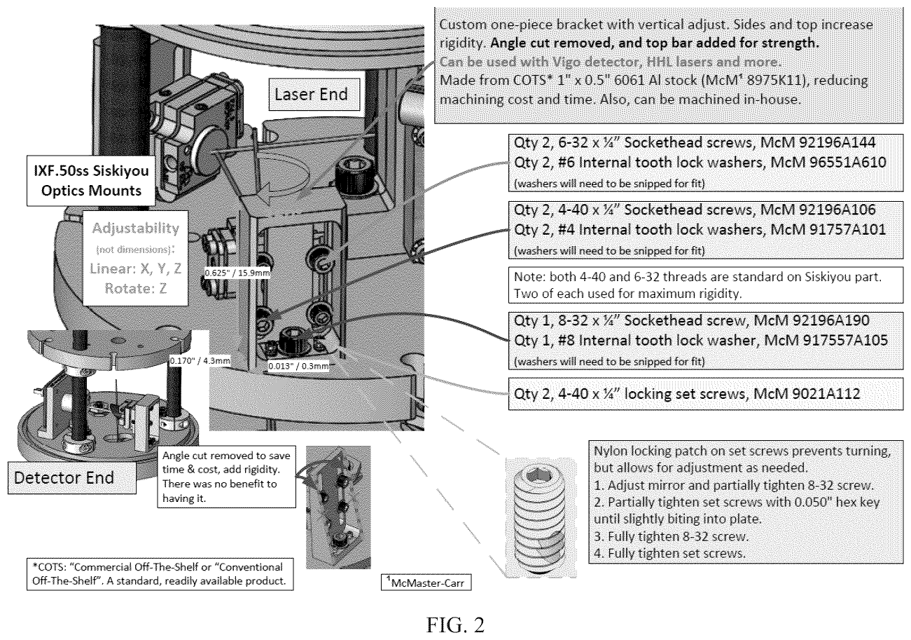

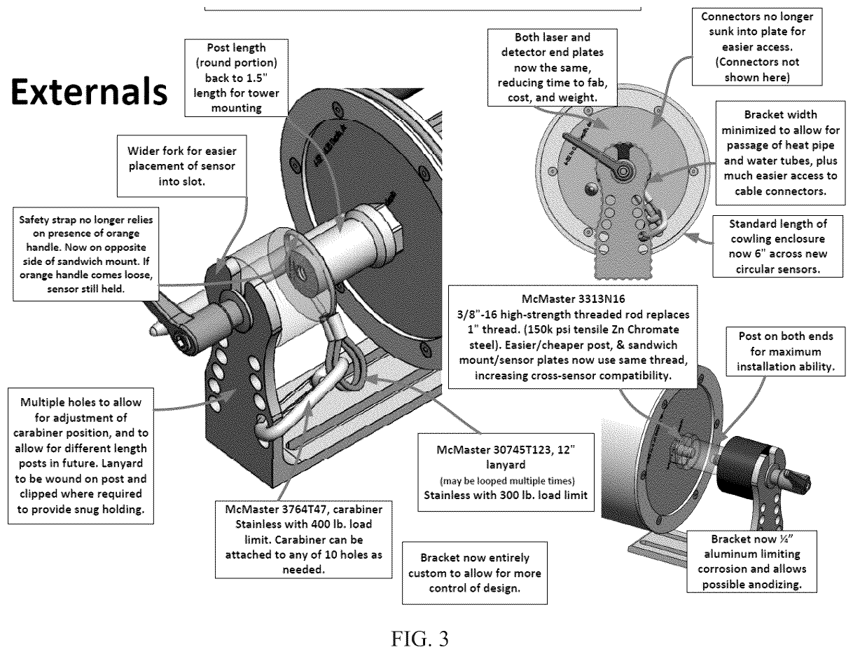

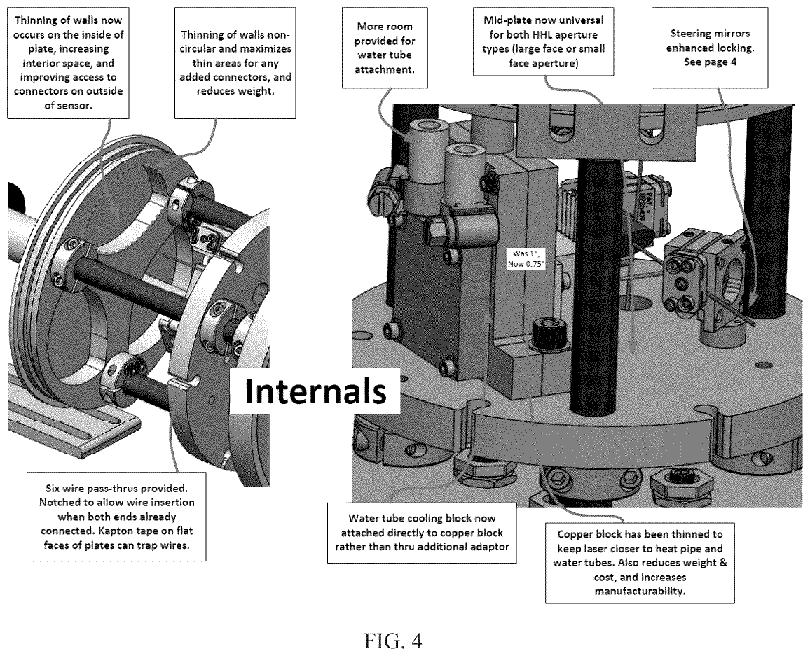

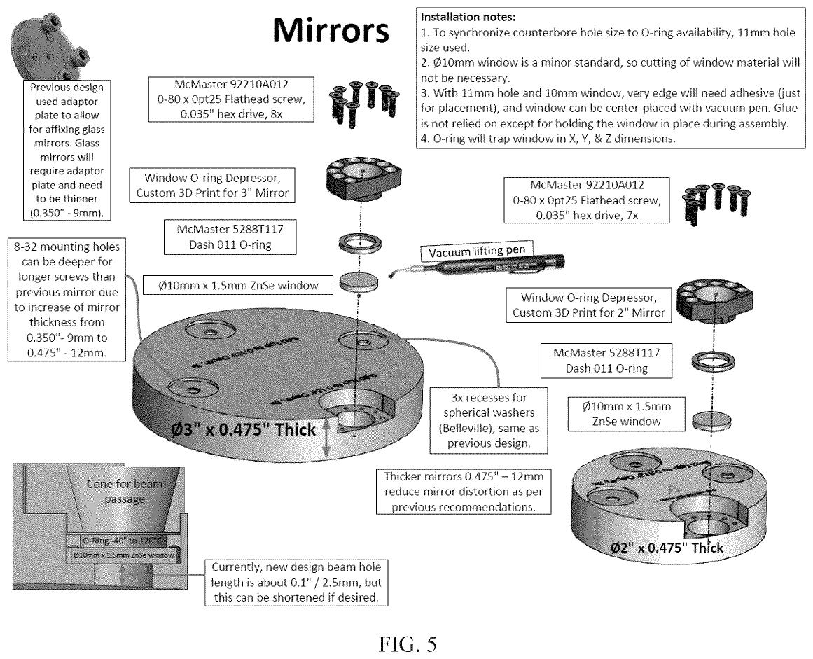

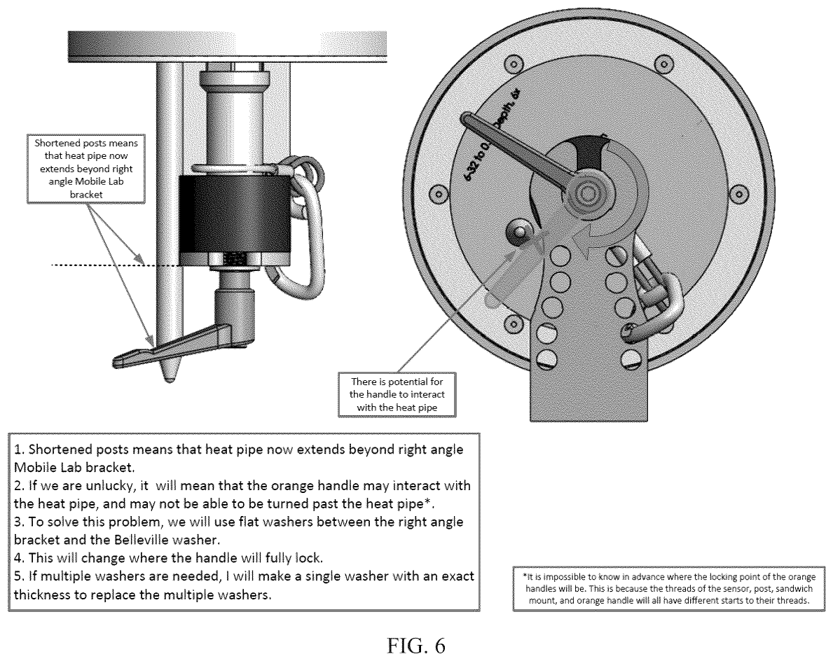

FIGS. 2-6 show schematic views of open-path sensing equipment according to some embodiment of the subject invention. Though FIGS. 2-6 list certain dimensions, materials, and component types, these are for exemplary purposes only and should not be construed as limiting. Open-path sensing equipment of embodiments of the subject invention can give concentration and/or flux measurement of analytes with excellent sensitivity. The open-path sensing equipment can include an optical cell comprising two chambers, each chamber made up of a plurality of plates (e.g., three plates) that may each be covered (e.g., with a cowling such as a cylindrical cowling). The two chambers can be separated by rods (e.g., adjustable rods), such as carbon fiber rods, to minimize temperature sensitivity and mass. For example, three rods can be disposed between the chambers. These two separated chambers can form an open-path Herriott cell where light can be reflected many times between the mirrors to achieve a longer pathlength (e.g., a pair of mirrors separated by 50 centimeters (cm) could have 50 reflections to yield a 25 meter optical pathlength between the mirrors). Insulated electrical cables can connect the two chambers to each other, and the cables can run through the rods, which may be hollow. One plate of the plurality of plates in each chamber can be referred to as the outer plate and can be a feedthrough for electrical cables and/or mounting of electric parts. A second plate of the plurality of plates in each chamber can have optical components disposed thereon, and the optical components can include at least one reflection (or focusing) mirror, at least one light source, a detector, and/or at least one alignment mirror. A third plate of the plurality of plates in each chamber can attach an optical cell mirror and/or a window, as well as at least one optional heater (e.g., if the sensing equipment is to be deployed in cold weather). The sensor can have a circular and/or cylindrical shape in order to minimize flow disruptions.

The at least one focusing mirror in each chamber can include a plurality of mirrors that may be attached with a three-axis mirror mount. Each mirror can be coated, for example with a metal (e.g., molybdenum, gold, silver, or aluminum). The mirrors can be, for example, 3-inch molybdenum mirrors. A wedged or anti-reflective coating (e.g., 99% anti-reflective at the given wavelength) window can be included on any or all of the windows. The window material can be, for example, ZnSe or other transparent material as wavelength appropriate (e.g., sapphire for a wavelength of less than 5 micrometers (μm)). The window can be either flat with the mirror surface or recessed within the (or each) mirror. The mirrors can be highly reflective in the mid-IR range (i.e., 2 micrometers (μm) to 30 μm). Any or all of the mirrors can include a central hole where a self-cleaning mechanism can be mounted, using for example a jet of air or water to clean the mirrors of dust and/or other debris. The at least one light source can be present in just one of the chambers, and the chamber can include a light source mounted on a mounting structure, such as a heat pipe (e.g., a copper heat pipe), and the mounting structure can be directly connected to a thermoelectric cooler (TEC) of the at least one light source for optimal heat dissipation.

The system can use wavelength modulation spectroscopy, direct absorption spectroscopy, or a combination thereof for obtaining concentrations. The use of wavelength modulation spectroscopy and direct absorption spectroscopy in combination, or an envelope extraction scheme of the wavelength modulation signal to derive the direct absorption signal, can allow for the determination of the actual analyte concentration with excellent sensitivity. In some embodiments, a line-locking scheme can be used that uses a laser light threshold of the at least one light source to avoid the use of a separate reference detector.

The system can include an electronics box in operable communication with the optical cell, and the electronics box can include a plurality of components that can each be either be off the shelf commercial or custom made. The components in the electronics box are what primarily limit the overall sensor's operating conditions, so components should be chosen to ensure an operating temperature range of −40° C. to 60° C. (or wider) to tolerate a diverse range of field environments, all while being in a ruggedized and protective case. In some embodiments, an industrial computer with the rugged temperature range can be used, as opposed to commercial/office style computer boards, which are more limited. Data acquisition cards (e.g., at least two data acquisition cards) can be needed (with at least two having both input and output functionality). One can be configured/used for fast measurements (spectroscopic data of the analyte measurements, which occurs thousands to millions of times a second), and one can be configured/used for slow measurements, for slower frequency parameters like temperature of the air, laser, and/or detector. This separation can prevent or inhibit undue electrical noise from contaminating the spectra signa while maintaining an appropriate amount of data (as too much becomes a hinderance). An opto-isolator can also be used when connecting the data acquisition card to the computer to decrease noise. In order to properly drive all the various electronic components, such as the thermoelectric controllers, laser driver, data acquisition cards, computer, and other features, at least one power supply can be used (e.g., a plurality of power supplies with different voltages as necessary for all the components).

The at least one light source can be, for example a laser (e.g., a quantum cascade laser (QCL), an interband cascade laser (ICL), a lead-salt laser, an antimonide laser, or laser light generated from a combination of laser beams such as difference frequency generation or frequency combs), a light emitting diode (LED), or any other light source that can emit modulated light at a given frequency and scan across an absorption feature (e.g., difference frequency generation, frequency combs, etc.). The at least one light source can probe the absorption feature of interest.

Each light source can be configured to provide light at a wavelength in the mid IR range, and at a specific wavelength for a particular analyte. That is, the sensing equipment can include at least one light source, which can include a first light source configured to provide light at a first mid-IR wavelength targeted to obtain the concentration of a first analyte, a second light source configured to provide light at a second mid-IR wavelength targeted to obtain the concentration of a second analyte, a third light source configured to provide light at a third mid-IR wavelength targeted to obtain the concentration of a third analyte, and/or a fourth light source configured to provide light at a fourth mid-IR wavelength targeted to obtain the concentration of a fourth analyte, etc. In the case where more than one light source is present, only one light source is operated at a time to obtain the concentration of a single analyte at a time.

The components of the system can be made from many different materials. For example, many of the structural parts can be machined from raw stock material according to specific engineering drawings generated from CAD models. The plates and the cowlings in the sensor can be rigid, such as metal (e.g., aluminum). The plates can also be composed of, or partially use, materials with a low coefficient of thermal expansion such as zerodur or invar. The heat pipe (if present) can be metal (e.g., copper). The optical mounts can be rigid, such as metal (e.g., aluminum, stainless steel). The use of stainless steel can help decrease thermal expansion or contraction effects, though stainless steel is more difficult than aluminum to machine. The parts should be able to tolerate (without failure) an operating temperature range of −40° C. to 60° C. (or wider). All the optical parts should be carefully aligned to form the correct laser tracing for light between the two mirrors of the optical cell. Any or all of the electrical connectors present can be custom made through soldering, though specific circuit boards or common cables can be commercially purchased for system integration. Software (e.g., custom built software code in LabView) can control the measurement process.

In some embodiments, the system can include an analyzer unit in operable communication with the sensor. The analyzer unit can be, for example, a computer with software stored thereon that is configured to receive the signals (or reflected light from the reflectors) and convert them to data indicative of the analyte concentration in the air. The optically absorbed signals can be converted via, for example, wavelength modulation spectroscopy or direct absorption spectroscopy, though embodiments are not limited thereto. The data indicative of the analyte concentration in the air can include spatial information (e.g., the concentration in space within the field). The analyzer unit can include custom FPGA electronics. The analyzer unit can be in the electronics box or can be remote (e.g., wirelessly connected to the sensor and/or the electronics box). The analyzer unit can be in operable communication with a display on which the data indicative of the analyte concentration in the air can be displayed. The display can be located on the electronics box or can be remote therefrom, in which case the data can be transmitted to the display wirelessly or via a wire (e.g., a buried wire). As the sensor moves around the field, a full picture of analyte concentration in the entire field can be obtained.

The sensing equipment can operate at a frequency in a range of, for example, from 1 Hertz (Hz) to 1000 Hz (or any subrange contained therein, such as from 1 Hz to 100 Hz or from 1 Hz to 10 Hz). In many embodiments, the sensing equipment operates at a frequency of 10 Hz.

The systems and methods of embodiments of the subject invention can detect analyte concentration in the air with a sensitivity/precision of 500 parts per billion (ppb) or less, such as 100 ppb or less, 50 ppb or less, 10 ppb or less, 1 ppb or less, about 0.1 ppb, or 0.1 ppb. These sensitivities can be obtained in the operating frequency range of the sensor (e.g., 1 Hz to 1000 Hz, or at 10 Hz). Higher precision is possible with longer pathlengths in a linear relationship.

The sensing equipment can further include and/or be operated with electronics, such as field programmable gate array (FPGA) (e.g., custom FPGA) electronics. The sensing equipment can be low power, using an amount of power during operation that is, for example, 60 watts (W) or less (e.g., 50 W or less, 40 W or less, in a range of from 20 W to 60 W, 50 W, or about 50 W).

The analyte can be a gas, such as N₂O, NH₃, methane (CH₄), carbon dioxide (CO₂), nitric oxide (NO), ozone (O₃), water vapor, or carbon monoxide (CO). In some embodiments, the concentration in the air of more than one analyte can be detected, and each analyte may be a gas (such as those listed in the previous sentence).

In many embodiments, a meteorology station (e.g., a three-dimensional sonic anemometer or similar meteorological sensor) can be mounted on at least one tower to record wind and/or other meteorological parameters. The sensing equipment and/or the analyzer unit can be in operable communication with the meteorology station. By combining the vertical wind measurements with the concentration at the frequency of measurement, a vertical flux of the analyte can be obtained through the implementation of eddy covariance methods.

Sensors of embodiments of the subject invention can use absorption features for select gases that minimize temperature effects (e.g., density via the ideal gas law, spectroscopic effects on absorption line-strengths). Specifically, an absorption line of 4.542 μm for N₂O and 9.06 μm for NH₃ can be used to avoid these complications. This approach can also be used to make multi-species greenhouse gas sensors for eddy covariance including improved CO₂, CH₄, water vapor, and NO measurements. The fundamental absorption bands can be used, specifically selected to minimize interference of other gases and minimize temperature, water vapor, and other spectroscopic corrections.

Embodiments of the subject invention can advantageously provide extremely accurate measurements (e.g., precision on the ambient levels of better than one part in one thousand) of the concentration in air of one or more different analytes, such as greenhouse gases and air pollutants. This can help ensure that any emissions or concentrations can be accurately documented for purposes of reporting, regulation, marketing, and/or claims on environmental sustainability. Also, hotspots of the analyte can be identified, allowing the owner of the property to potentially address the hotspot and decrease air emissions. This has environmental and economic advantages (e.g., more efficient operation, lower risk of fines, recovery of lost products).

The methods and processes described herein can be embodied as code and/or data. The software code and data described herein can be stored on one or more machine-readable media (e.g., computer-readable media), which may include any device or medium that can store code and/or data for use by a computer system. When a computer system and/or processor reads and executes the code and/or data stored on a computer-readable medium, the computer system and/or processor performs the methods and processes embodied as data structures and code stored within the computer-readable storage medium.

It should be appreciated by those skilled in the art that computer-readable media include removable and non-removable structures/devices that can be used for storage of information, such as computer-readable instructions, data structures, program modules, and other data used by a computing system/environment. A computer-readable medium includes, but is not limited to, volatile memory such as random access memories (RAM, DRAM, SRAM); and non-volatile memory such as flash memory, various read-only-memories (ROM, PROM, EPROM, EEPROM), magnetic and ferromagnetic/ferroelectric memories (MRAM, FeRAM), and magnetic and optical storage devices (hard drives, magnetic tape, CDs, DVDs); network devices; or other media now known or later developed that are capable of storing computer-readable information/data. Computer-readable media should not be construed or interpreted to include any propagating signals. A computer-readable medium of embodiments of the subject invention can be, for example, a compact disc (CD), digital video disc (DVD), flash memory device, volatile memory, or a hard disk drive (HDD), such as an external HDD or the HDD of a computing device, though embodiments are not limited thereto. A computing device can be, for example, a laptop computer, desktop computer, server, cell phone, or tablet, though embodiments are not limited thereto.

When ranges are used herein, combinations and subcombinations of ranges (e.g., any subrange within the disclosed range) and specific embodiments therein are intended to be explicitly included. When the term “about” is used herein, in conjunction with a numerical value, it is understood that the value can be in a range of 95% of the value to 105% of the value, i.e. the value can be +/−5% of the stated value. For example, “about 1 kg” means from 0.95 kg to 1.05 kg.

A greater understanding of the embodiments of the subject invention and of their many advantages may be had from the following examples, given by way of illustration. The following examples are illustrative of some of the methods, applications, embodiments, and variants of the present invention. They are, of course, not to be considered as limiting the invention. Numerous changes and modifications can be made with respect to embodiments of the invention.

### Example 1

Three different sensing systems were fabricated. Each had an aluminum body that was machined from aluminum and then anodized. Adjustable carbon fiber rods were used to hold the cell together and minimize thermal expansion. Aluminum optical mounts were used to hold two gold coated ½-inch flat alignment mirrors and the laser. The reflection mirrors were window-free 2-inch gold-coated spherical reflection mirrors with a water-jet cut slot through which light can enter and leave the cell. In order to prepare and protect the reflection mirrors for the water jetting process the reflection mirrors were heated and coated with paraffin wax. Each reflection mirror was then cut, heated again, and the wax removed. Next, each reflection mirror was epoxied into an aluminum plate that was attached with screws to the rest of the aluminum body. An off-axis parabolic mirror was used to focus the light that exits the multi-pass cell onto an MCT detector. Wiring for the detector went through a shielded cable through the hollow carbon fiber rods between the mirrors. The optical housings surrounding the back side of the mirrors were made with 3D-printed materials. All the electrical components and wires in the optical cell were ultimately joined into a single shielded cable that connected to an external aluminum box housing the custom FPGA electronics. A GPS receiver and external battery connected to the electronics box. The electronics box and battery were housed on a bottom the UAV and the multi-pass cell was housed on top to minimize landing functionality of the UAV. The UAV was a DJI Matric 350 quadcopter UAV. Each sensing system was operated with the custom FPGA electronics with a Linux based operating system and a modbus interface.

The three sensing systems differed by the laser. One had a QCL configured to measure N₂O; one had an ICL configured to measure N₂O; and one had a QCL configured to measure NH₃.

Each sensing system operated at 10 Hz at a precision of 0.1 ppb, using 6 W of power, and weighing about 2.7 kg (including all cables and a battery). Each sensing system effectively produced spatial maps of emissions and concentrations of the target analyte (N₂O or NH₃).

It should be understood that the examples and embodiments described herein are for illustrative purposes only and that various modifications or changes in light thereof will be suggested to persons skilled in the art and are to be included within the spirit and purview of this application.

All patents, patent applications, provisional applications, and publications referred to or cited herein are incorporated by reference in their entirety, including all figures and tables, to the extent they are not inconsistent with the explicit teachings of this specification.

### REFERENCES

1. Sun et. al., sciencedirect.com/science/article/pii/S0168192315001860
2. Pan et. al., onlinelibrary.wiley.com/doi/full/10.1111/gcb.15986
3. Miller et. al., amt.copernicus.org/articles/7/81/2014/

What is claimed is:

1. A system for measuring at least one analyte in air over an area, the system comprising:
open-path sensing equipment; and
an analyzer unit in operable communication with the open-path sensing equipment, wherein the open-path sensing equipment comprises:
at least one mid-infrared (mid-IR) light source disposed thereon and configured to provide light at a predetermined wavelength for a particular analyte, wherein the predetermined wavelength is in a range of from 2 micrometers (μm) to 30 μm;
a plurality of reflection mirrors configured to reflect light from each mid-IR light source; and
a detector configured to receive signals of light reflected from the plurality of reflection mirrors.

2. The system according to claim 1, further comprising:
an airborne vehicle having the open-path sensing equipment mounted thereon; and
a meteorology station in operable communication with the analyzer unit, wherein the meteorological station is configured to obtain meteorological data of the air on the airborne vehicle,
wherein the meteorological data comprises wind speed, wind direction, air pressure, air temperature, humidity, or a combination thereof.

3. The system according to claim 1, wherein each analyte of the at least one analyte is a greenhouse gas or air pollutant, and
wherein the system is configured to measure the at least one analyte with a sensitivity of 100 parts per billion (ppb) or less.

4. The system according to claim 2, wherein each reflection mirror of the plurality of reflection mirrors is a spherical mirror,
wherein each reflection mirror of the plurality of reflection mirrors is gold-coated,
wherein the open-path sensing equipment further comprises a pair of alignment mirrors,
wherein each alignment mirror of the pair of alignment mirrors is flat, and
wherein each alignment mirror of the pair of alignment mirrors is gold-coated.

5. The system according to claim 2, wherein the open-path sensing equipment further comprises adjustable rods between reflection mirrors of the plurality of reflection mirrors.

6. The system according to claim 2, wherein the open-path sensing equipment further comprises an off-axis parabolic mirror configured to focus the light reflected from the plurality of reflection mirrors onto the detector.

7. The system according to claim 2, wherein the open-path sensing equipment is configured such that the light has a number of passes after it is provided by the at least one light source and before it is reaches the detector, wherein the number of passes is in a range of from 2 passes to 200 passes.

8. The system according to claim 1, wherein the analyzer unit comprises software stored thereon that is configured to receive the signals of light reflected from the plurality of reflection mirrors and convert them to data indicative of a concentration of the at least one analyte in the air, and
wherein the data indicative of the concentration of the at least one analyte in the air comprises spatial information of the concentration of the at least one analyte in the air.

9. The system according to claim 8, wherein the analyzer unit converts the signals via wavelength modulation spectroscopy, direct absorption spectroscopy, or both.

10. The system according to claim 1, wherein the open-path sensing equipment is configured to operate at a frequency in a range of from 1 Hertz (Hz) to 1000 Hz.

11. The system according to claim 2, further comprising:
a global positioning satellite (GPS) receiver disposed on the airborne vehicle and in operable communication with the open-path sensing equipment; and
an external battery disposed on the airborne vehicle and configured to provide power to the open-path sensing equipment.

12. The system according to claim 2, wherein the system is configured such that during operation the system uses a power of 10 watts (W) or less,
wherein the system excluding the airborne vehicle has a total weight of about 3 kilograms (kg) or less, and
wherein the open-path airborne vehicle is an unmanned aerial vehicle (UAV).

13. A method for measuring at least one analyte in air over an area, the method comprising:
i) providing the system according to claim 2;
ii) operating the open-path sensing equipment;
iii) operating the airborne vehicle such that it moves over at least a majority of the area while the open-path sensing equipment is being operated; and
iv) using the analyzer unit to convert signals of reflected light in the open-path sensing equipment to data indicative of a concentration of the at least one analyte in the air.

14. The system according to claim 1, further comprising a meteorology station in operable communication with the analyzer unit, wherein the meteorological station is configured to obtain meteorological data of the air over the area, air adjacent to the area, or both,
wherein the meteorological data comprises wind speed, wind direction, air pressure, air temperature, humidity, or a combination thereof, and
wherein the meteorology station is disposed within or adjacent to the area.

15. The system according to claim 14, wherein each reflection mirror of the plurality of reflection mirrors is attached to a three-axis mirror mount,
wherein each reflection mirror of the plurality of reflection mirrors is a molybdenum mirror,
wherein the open-path sensing equipment further comprises at least one alignment mirror,
wherein the open-path sensing equipment further comprises two chambers attached to each other by a plurality of rods,
wherein each chamber of the two chambers comprises a plurality of plates each covered with a cylindrical cowling, and
wherein each rod of the plurality of rods is adjustable.

16. The system according to claim 14, wherein each reflection mirror of the plurality of reflection mirrors comprises a transparent coating window that has an anti-reflective coating or wedged surface configured to minimize back reflections, and
wherein the transparent coating window is flat or recessed within the respective reflection mirror.

17. The system according to claim 14, further comprising at least one power source configured to provide power to the open-path sensing equipment,
wherein the system is configured such that during operation the system uses a power of 60 watts (W) or less.

18. The system according to claim 14, wherein:
the open-path sensing equipment is mounted on a tower disposed in or adjacent to the area; or
the open-path sensing equipment is mounted on a moving object.

19. The system according to claim 14, wherein the system is configured to operate without failure at all temperatures in a range of from −40° C. to 60° C.

20. A method for measuring at least one analyte in air over an area, the method comprising:
i) providing the system according to claim 14;
ii) operating the open-path sensing equipment; and
iii) using the analyzer unit to convert signals of reflected light in the open-path sensing equipment to data indicative of a concentration of the at least one analyte in the air.
